(19) United States
(12) Patent Application Publication
(10) Pub. No.: US 2002/0155333 A1
(43) Pub. Date: Oct. 24, 2002

(54) Apparatus and method for electrochemical cell components

(76) Inventors: Bruce B. Fitts, Danielson, CT (US); Vincent R. Landi, Phoenix, AZ (US); Saroj Kumar Roy, Danielson, CT (US); Brian C. Johnson, Tampa, FL (US); Scott G. Ehrenbert, New Port Richey, FL (US)

Correspondence Address: CANTOR COLBURN, LLP, 55 GRIFFIN ROAD SOUTH, BLOOMFIELD, CT, 06002

(21) Appl. No.: 10/053,346

(22) Filed: Jan. 18, 2002

Related U.S. Application Data
(60) Provisional application No. 60/263,010, filed on Jan. 19, 2001.
(60) Provisional application No. 60/262,991, filed on Jan. 19, 2001.

(51) Int. Cl. H01M 8/04; H01M 8/02; H01M 2/08

(52) U.S. Cl. 429/26; 429/120; 429/38; 429/22; 429/36

(57) ABSTRACT

A component for an electrochemical cell comprises a thermally and electrically conductive core with an active area substantially covered by an electrically and thermally conductive polymeric composite, wherein the conductive polymeric composite is adhered to the core by an adhesion promoter. The electrically conductive polymeric composite preferably comprises a thermosetting polybutadiene- or polyisoprene-based resin system and an electrically conductive filler. The component is resistant to chemical attack and hydrolysis, and has excellent mechanical strength and toughness. Components may be manufactured having a volume resistivity of about 0.500 ohm-cm or less and a thermal conductivity of at least about 5 watts/meter ° K,. In addition, the component is economical to produce due to inexpensive starting materials as well as the use of conventional processing equipment.

### CROSS REFERENCE TO RELATED APPLICATIONS

This application claims priority pursuant to 35 U.S.C. 119(e) to U.S. Application Serial No. 60/263,010 filed Jan. 19, 2001 and U.S. Application Serial No. 60/262,991 filed Jan. 19, 2001, the above applications being incorporated herein by reference in their entirety including incorporated material.

### BACKGROUND OF THE INVENTION

This invention relates to electrochemical cells, and in particular to electrochemical cell components and materials useful in the manufacture of components.

Electrochemical cells may be classified as either electrolysis cells or fuel cells. Electrolysis cells act as hydrogen generators by electrolytically decomposing water to produce hydrogen and oxygen gases. Fuel cells function by electrochemically reacting a fuel gas such as hydrogen with an oxidant gas such as air or oxygen to generate electricity. A preferred type of electrochemical cell is the “proton exchange membrane” cell, wherein the cathode of the cell is separated from the anode by a proton exchange membrane that facilitates the diffusion of ions and/or water between the cathode and anode, but prohibits the diffusion of fuel and oxidant gases.

The typical electrochemical cell includes a number of individual cells arranged in a stack, with the working fluid directed through the cells via input and output conduits formed within the stack structure. The cells within the stack are sequentially arranged, each including a cathode, a proton exchange membrane, and an anode. Membrane electrode assemblies (MEA) for use in fuel cells are well known, being described for example in U.S. Pat. Nos. 5,272,017 and 3,134,697, which are incorporated by reference herein. The MEA for each cell, sandwiched between electrically conductive gas diffusion layers, is placed between a pair of electrically conductive elements or plates which serve as current collectors for the anode/cathode, and which generally contain an array of grooves in the faces thereof for distributing the gaseous reactants (a fuel gas such as H₂ and an oxidant gas such as O₂ or air) over the surfaces of the anode and cathode. Such plates are described, for example, in U.S. Pat. Nos. 4,988,583, 5,521,018, and 6,261,710B1. The gaseous reactants are usually saturated, typically with water. Each cathode/membrane/anode assembly (hereinafter “membrane electrode assembly”, or “MEA”) is typically supported on both sides by flow fields comprising screen packs. Such flow fields facilitate fluid movement and membrane hydration and provide mechanical support for the MEA.

A plurality of such cells may be stacked together as a fuel cell stack and connected in electrical series. The stack of cells is also called a “fuel cell” in the art. The cells are separated from each other by an impermeable, electrically conductive plate referred to as a bipolar plate. The bipolar plate thus serves as an electrically conductive separator element between two adjacent cells, and generally also has reactant gas distributing grooves on both external faces thereof. In most cases the bipolar plate also has internal passages through which coolant flows to remove heat from the stack. In the electrochemical cell environment, the active areas of the exterior faces of the bipolar plates are in constant contact with often highly corrosive, acidic solutions at elevated temperatures. Moreover, at least one of the electrode faces may be polarized in the presence of pressurized, saturated air or hydrogen. To survive in such an environment, the bipolar plates must be able to withstand these pressures and be highly resistant to corrosion and degradation. In addition to the bipolar plates placed between each fuel cell, end plates may be necessary to contain the fuel cell stack. The end plates must withstand the same corrosive environment as the bipolar plates.

Bipolar plates are often fabricated from graphite or corrosion resistant metals. Graphite is lightweight, corrosion resistant, and electrically conductive but is also quite brittle and thus prone to cracking, and mechanically difficult to handle, thus increasing production costs. Additionally, graphite is porous, making it very difficult to make the very thin, gas-impervious plates that are desirable for low-weight, low-volume fuel cell stacks. The graphite plates must also be operably connected to the other components by seal rings. Typically the seal ring material contains plasticizers and additives that leach out over time and contaminate the catalyst. Catalyst contamination generally halts energy production. Graphite plates also have relatively low heat conductivity, which does not allow heat generated in the cell to be conducted laterally to the edges of the cell by thermal conductivity. Graphite plates must then be further complicated by having coolant liquid channels formed in them.

Corrosion-resistant metals are generally more electrically conductive but these materials typically have low thermal conductivity and, similar to graphite, bipolar plates formed from these materials also require coolant liquid channels.

Accordingly, there is a perceived need in the art for electrically and thermally conductive low cost components for electrochemical cells, particularly bipolar plates and end plates, with high mechanical integrity and high chemical resistance.

### BRIEF SUMMARY OF THE INVENTION:

The above described drawbacks and deficiencies in the prior art are overcome by a component for an electrochemical cell comprising a thermally and electrically conductive core with an active area substantially covered by an electrically and thermally conductive polymeric composite adhered to the core by an adhesion promoter. Preferably the conductive polymeric composite has a coefficient of thermal expansion substantially matching to the core material. For the purpose of this specification, the coefficients of thermal expansion are substantially matched if the electrochemical cell component can be cycled through the normal fuel cell temperature cycle or between the curing temperature of the material and the lowest temperature specified for the fuel cell, and the stress caused by differential expansion and/or contraction does not pull the polymeric composite from the core, cause the polymeric composite to crack or otherwise allow corrosive material to reach the core, or cause the electrochemical cell component to bow as the temperature is cycled. Use of an adhesion promoter alleviates the tendency of the core and the conductive polymeric composite to debond, despite any disparity in dimensional stability of the core and conductive polymeric composite, surprisingly without significant decrease in either electrical or thermal conductivity of the component. The conductive polymeric composite preferably comprises a thermosetting polybutadiene- or polyisoprene-based resin system and an electrically conductive filler.

The above discussed and other features and advantages of the present invention will be appreciated and understood by those skilled in the art from the following detailed description.

### BRIEF DESCRIPTION OF THE DRAWINGS

FIG. 1 and 2 are cross sectional drawings of heat conducting plates.

FIG. 3 is a cross sectional drawing of a heat conducting plate with channels.

FIGS. 4-6 are cross sectional drawings of bipolar plates.

FIG. 7 is a schematic representation of a fuel cell stack.

FIG. 8 is a schematic representation of a heat conducting plate with coolant channels.

FIG. 9 is a schematic representation of a bipolar plate.

FIGS. 10 and 11 are schematic representations of fuel cell stacks.

### DETAILED DESCRIPTION OF THE PREFERRED EMBODIMENTS:

A component for an electrochemical cell comprises an electrically and thermally conductive core having an active area substantially covered by a thermally and electrically conductive polymeric composite adhered to the core by an adhesion promoter. Preferably, the component is an electrically conductive support such as a bipolar or end plate. Typically the high filler loadings required to make a polymeric coating electrically conductive severely decreases the adhesion of the conductive polymeric coating to a substrate such as the conductive core described herein. Use of a thin layer of an adhesion promoter between the core and the conductive polymeric composite alleviates the tendency of the core and polymer to debond, despite any disparity in the dimensional stability of the core and polymer layers, and surprisingly without significant decrease in either electrical or thermal conductivity. As described above, the coefficients of thermal expansion of the core and the conductive polymeric composite are substantially matched.

The active area is defined as the area of the core and polymeric composite adjacent to the corrosive cell environment. Substantially covered is defined as covered over at least 98% of the surface exposed to the corrosive environment, preferably covered over at least 99% of the surface exposed to the corrosive environment and most preferably covered over 99.9% of the surface exposed to the corrosive environment. The surface of the conductive polymeric composite should be substantially free of pinholes and cracks that might allow corrosive material to attack the core. The conductive polymeric composite may be patterned or unpatterned. The conductive polymeric composite should have a minimum thickness tₘᵢₙ over the core to prevent material from the corrosive environment from attacking the core material. tₘᵢₙ is preferably less than about 1.3 millimeters, more preferably less than about 0.6 millimeters, and most preferably less than about 0.4 millimeters.

Parts of the core may be left uncoated in areas where the core must be sealed, or in areas of the core where heat may be transferred to a heat transfer fluid. Heat transfer fluids (or cooling fluids) include both liquids and gases. Advantageously, the high thermal conductivity of the electrochemical cell component allows the heat generated by the cell to be laterally conducted and transferred to circulating fluids such as air thus reducing the complexity of the component and its manufacture.

The component is resistant to chemical attack and hydrolysis and has excellent mechanical strength and toughness. Components may be manufactured having a volume resistivity of about 0.500 ohm-cm or less, preferably about 0.116 ohm-cm or less, more preferably about 0.045 ohm-cm or less, and a thermal conductivity of at least about 5 watts/meter ° K, preferably about 7 watts/meter ° K, and more preferably at least about 13 watts/meter ° K.

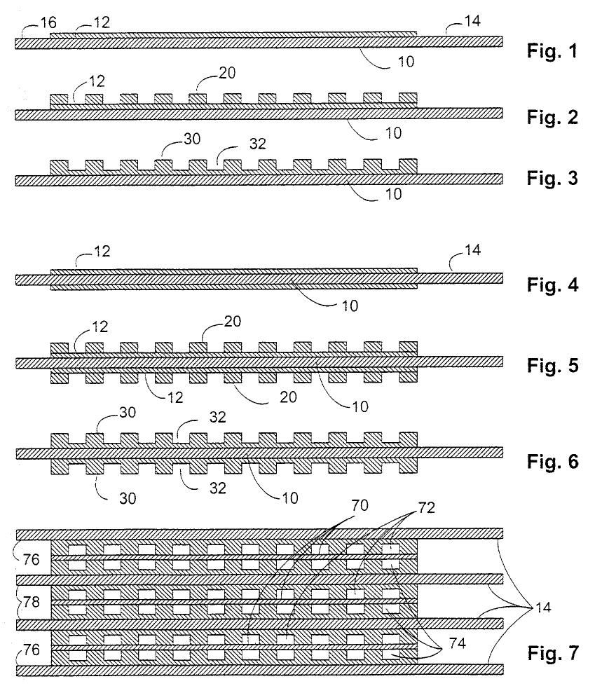

FIG. 1 shows a cross sectional drawing of an embodiment of a heat conducting plate 10 having an electrical and heat conducting polymeric composite 12 adhered over an active area of core 16 as a protective coating. In general, the thermal conductivity of plate 10 is much greater than that of material 12. An area 14 of the heat conducting plate 10 is shown left uncovered for later use as a heat transfer area. Preferably, the thermal conductivity of the plate 10 is great enough that this is little temperature gradient along the surface of plate 10, and there is sufficient conductivity to remove heat generated by the fuel cell in the active area to the heat transfer area 14 for removal to ambient air with a simple fan cooling system. Although plate 10 is shown in cross section as a parallel plate with flat surfaces of active area and heat transfer area coplanar, the invention is not limited to such a cross section. In particular, the active areas and heat transfer areas need not be flat. For the heat transfer area 14 to conduct heat generated by the cell in the active area, however, the part of the substrate connecting the active area to the heat transfer area must be a sufficiently good heat conductor.

FIG. 2 shows an embodiment of FIG. 1 with an additional material 20 disposed on top of the polymeric composite 12 to form channels for channeling fuel or oxidant gases. The material 20 should be sufficiently heat and electrically conductive to conduct the heat and electricity generated in the fuel cell with little loss in voltage and little temperature gradient. The material 20 may be identical to material 12, or may be a different material.

FIG. 3 shows an embodiment of the invention where the electrically and heat conducting material 30 is bonded the plate 10 and molded to have channels.

FIGS. 4, 5 and 6 show embodiments of the invention similar to those of FIGS. 1-3, but have conductive polymeric composite on both sides of the plate to make a bipolar plate. FIG. 7 shows a sketch of a fuel cell stack. MEA's 70 are sandwiched between bipolar plates to form fuel gas channels 72 and oxidant gas channels 74. Two endplates 76 and two bipolar plates 78 are shown. Each MEA 70 is shown as a single layer, even though it comprises multiple layers of electrode, catalyst material, and membrane ion transport material. The heat transfer areas 14 of each plate are shown in cross section to be a series of fins which can be easily air cooled by fan cooling means. Other cooling means such as liquid cooling means are also anticipated by the inventors for cooling the fins shown in FIG. 7.

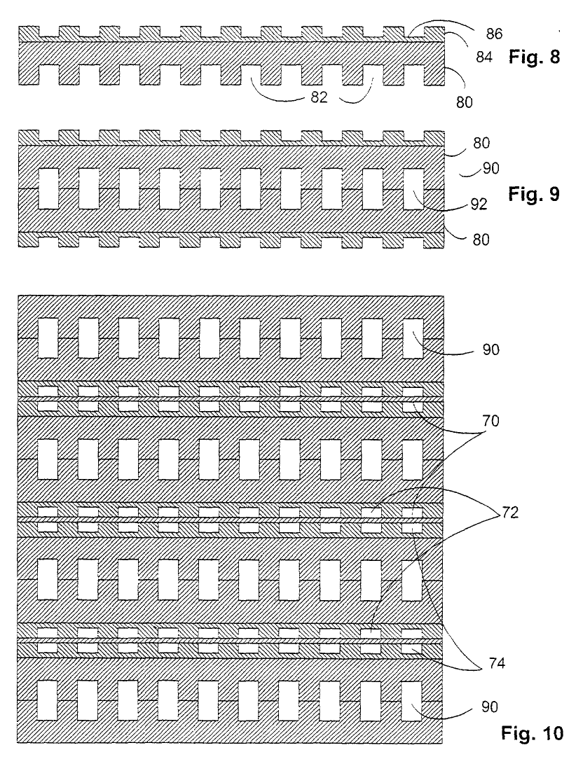

FIG. 8 shows a sketch of a metal or other heat conducting plate 80 formed with channels 82 which will later form coolant channels. Protective polymeric composite 84 is shown molded on to the plate 80 with channels 86 which will later form fuel or oxidant gas channels.

FIG. 9 shows two of the plates 80 of FIG. 8 joined to form a bipolar plate 90 with channels 92 for channeling coolant fluids such as water or oil or air or another gas.

FIG. 10 shows a fuel cell stack having two bipolar plates such as sketched in FIG. 9 sandwiched between MEA's, as well as two end plates formed in the same manner as shown in FIG. 9.

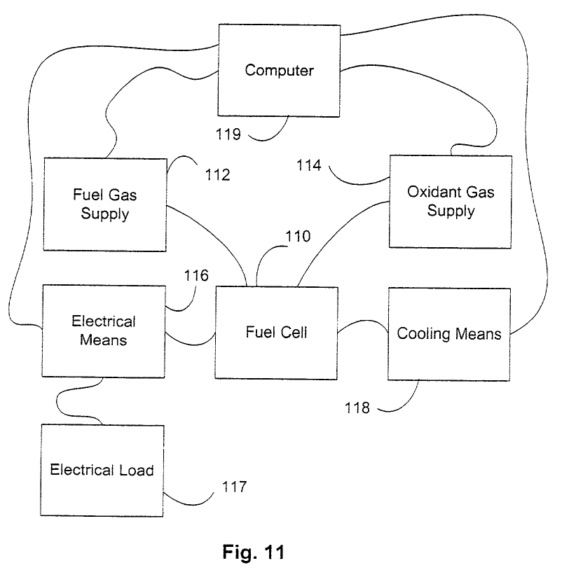

FIG. 11 shows a sketch of a fuel cell stack 110 connected to sources 112 and 114 of fuel and oxidant gases. A means 116 for conditioning electricity produced by the fuel cell stack and a load 117 for using the electricity are shown connected to the fuel cell by appropriate electrical connections. A means 118 for cooling the fuel cell stack is shown connected to the fuel cell stack by appropriate cooling lines. Control means 119 controls fuel, oxidant, electrical conditioning, and cooling. Control means 119 may be separated in each function, or may be centralized in on central location as by a computer or other microprocessor, or may be any combination of microprocessors and/or controllers connected to control the system.

Cross sectional sketches shown in FIGS. 1-10 should not be considered as limiting the invention. In particular, fuel and oxidant channels are shown running in the same direction for clarity of expression, even though they may run at right angles and/or have complicated serpentine and branching channels.

The core material is electrically conductive and has high thermal conductivity as well. The core material may be metal, non-metallic or a combination of metallic and non-metallic materials. Useful metal cores comprise aluminum and aluminum alloys, nickel and nickel alloys, copper, copper alloys, platinum, magnesium, magnesium alloys, gold-plated metals, and stainless steel. The core material preferably has a coefficient of thermal expansion that closely matches the coefficient of thermal expansion of the molded composite. Additionally, core materials with a comparatively low density such as aluminum are preferred due to the resulting decrease in the weight of the fuel cell. The desired dimensions of the electrochemical cell component typically dictate the dimensions and shape of the core. Typically, the shape and dimension of the component depend upon the structure of the electrochemical cell as well as the contemplated end use of the electrochemical cell. In general, however, the component has thickness usually about 1 mm to about 15 mm thick and length l and width w greater than about 10 cm to about 15 cm. Similarly, the thickness of the core also varies. Typical thickness is about 0.01 cm to about 0.25 cm, depending on the amount of heat to be carried. The thickness is usually much smaller than the length and width of the core. The final shape and geometry of the core will be dictated by requirements of electrochemical cell design.

Useful adhesion promoters include adhesion promoters capable of adhering to both the surface of the core and the conductive polymeric coating. Examples include various compounds based on silicon, titanium, and zirconium.

Useful titanium based compounds include, but are not limited to, monoalkoxy titanates such as isopropyl tri(N-ethylaminoethylamino) titanate, isopropyl tri-isostearoyl titanate and titanium di(dioctylpyrophosphate) oxyacetate; coordinate titanates such as tetraisopropyl di(dioctylphosphito)titanate; and neoalkoxy titanates such as neoalkoxy tris(dodecanoyl) benzenes sulfonyl zirconate, neoalkoxy tri(p-N-(beta-aminoethyl)aminophenyl)titanate. Other types include chelate, quaternary and cycloheteroatom titanates.

Useful zirconium based compounds include, but are not limited to, neoalkoxy zirconates such as neoalkoxy trisneodecanoyl zirconate, neoalkoxy tris(dodecanoyl) benzene sulfonyl zirconate, neoalkoxy tris(m-aminophenyl) zirconate, ammonium zirconium carbonate and zirconium propionate.

Useful silicon based compounds include a wide variety of silanes. One type of useful silane is represented by the formula

R₄₋ₙSiKₙ (I)

wherein R is an alkyl or aryl group, or a functional group represented by the formula

CₓH₂ₓY (II)

wherein x is from 0 to 20 and Y is selected from the group consisting of amino, amido, hydroxy, alkoxy, halo, mercapto, carboxy, acyl, vinyl, allyl, styryl, epoxy, isocyanato, glycidoxy and acryloxy groups. K is a hydrolyzable group, such as alkoxy (e.g., methoxy, ethoxy, and the like), phenoxy, acetoxy, and the like, or halogen (e.g., chlorine); and n is 1, 2, 3 or 4, and preferably n is 3. The adhesion promoters represented by formula (I) include halosilanes, aminoalkoxysilanes, aminophenylsilanes, phenylsilanes, heterocyclic silanes, N-heterocyclic silanes, acrylic silanes and mercapto silanes. Mixtures of two or more silanes also are useful. In one embodiment K is OR wherein R is an alkyl group containing up to about 5 carbon atoms or an aryl group containing up to about 8 carbon atoms. In other embodiments x is an integer from 0 to 10 and more often from 1 to about 5.

The adhesion promoter can be an epoxy silane represented by the formula

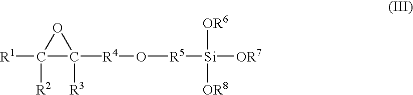

wherein: R¹, R² and R³ are independently hydrogen or hydrocarbon groups; R⁴ and R⁵ are independently alkylene or alkylidene groups; and R⁶, R⁷ and R⁸ are independently hydrocarbon groups. The hydrocarbon groups preferably contain 1 to about 10 carbon atoms, more preferably 1 to about 6 carbon atoms, more preferably 1 to about 4 carbon atoms. These hydrocarbon groups are preferably alkyl. The alkylene or alkylidene groups R⁴ and R⁵ preferably contain from 1 to about 10 carbon atoms, more preferably 1 to about 6 carbon atoms, more preferably 1 to about 4 carbon atoms, more preferably 1 or 2 carbon atoms. The alkylene and alkylidene groups can be methylene, ethylene, propylene, and the like.

The adhesion promoter can also be an acrylic silane represented by the formula

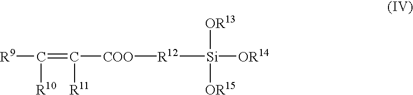

wherein: R⁹, R¹⁰ and R¹¹ are independently hydrogen or hydrocarbon groups; R¹² is an alkylene or alkylidene group; and R¹³, R¹⁴ and R¹⁵ are independently hydrocarbon groups. The hydrocarbon groups preferably contain 1 to about 10 carbon atoms, more preferably 1 to about 6 carbon atoms, more preferably 1 to about 4 carbon atoms. These hydrocarbon groups are preferably alkyl (e.g., methyl, ethyl, propyl, and the like). The alkylene and alkylidene groups preferably contain from 1 to about 10 carbon atoms, more preferably 1 to about 6 carbon atoms, more preferably 1 to about 4 carbon atoms. The alkylene groups include methylene, ethylene, propylene, and the like

The adhesion promoter additionally can be an amino silane represented by the formula

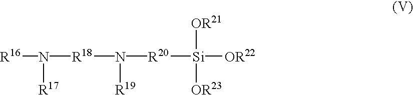

wherein: R¹⁶, R¹⁷ and R¹⁹ are independently hydrogen or hydrocarbon groups; R¹⁸ and R²⁰ are independently alkylene or alkylidene groups; R²¹, R²² and R²³ are independently hydrocarbon groups; and n is 0 or 1. The hydrocarbon groups preferably contain 1 to about 10 carbon atoms, more preferably 1 to about 6 carbon atoms, more preferably 1 to about 4 carbon atoms. These hydrocarbon groups are preferably alkyl (e.g., methyl, ethyl, propyl, and the like). The alkylene and alkylidene groups preferably contain from 1 to about 10 carbon atoms, more preferably 1 to about 6 carbon atoms, more preferably 1 to about 4 carbon atoms. The alkylene groups include methylene, ethylene, propylene, and the like

Mercapto silane adhesion promoters can be represented by the formula

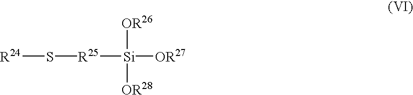

wherein R²⁴ is hydrogen or a hydrocarbon group; R²⁵ is an alkylene or alkylidene group; and R²⁶, R²⁷ and R²⁸ are independently hydrocarbon groups. The hydrocarbon groups preferably contain 1 to about 10 carbon atoms, more preferably 1 to about 6 carbon atoms, more preferably 1 to about 4 carbon atoms. These hydrocarbon groups are preferably alkyl (e.g., methyl, ethyl, propyl, and the like). The alkylene and alkylidene groups preferably contain from 1 to about 10 carbon atoms, more preferably 1 to about 6 carbon atoms, more preferably 1 to about 4 carbon atoms. These groups are preferably alkylene (e.g., methylene, ethylene, propylene, and the like).

Vinyl adhesion promoter can be represented by the formula

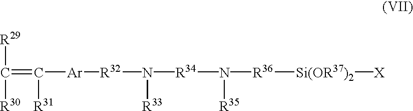

wherein: R²⁹, R³⁰, R³¹, R³³ and R³⁷ are independently hydrogen or hydrocarbon groups; R³², R³⁴ and R³⁶ are independently alkylene or alkylidene groups; each R³⁷ is independently a hydrocarbon group; Ar is an aromatic group; and X is a halogen. The hydrocarbon groups preferably contain 1 to about 10 carbon atoms, more preferably 1 to about 6 carbon atoms, more preferably 1 to about 4 carbon atoms. The hydrocarbon groups are preferably alkyl (e.g., methyl, ethyl, propyl, and the like). The alkylene and alkylidene groups preferably contain from 1 to about 10 carbon atoms, more preferably 1 to about 6 carbon atoms, more preferably 1 to about 4 carbon atoms. These groups are preferably alkylene (e.g., methylene, ethylene, propylene, and the like). The aromatic group Ar can be mononuclear (e.g., phenylene) or polynuclear (e.g., naphthylene) with the mononuclear groups and especially phenylene being preferred. The halogen, X, is preferably chlorine or bromine, more preferably chlorine.

Finally, the adhesion promoter can be a bis-silane represented by the formula

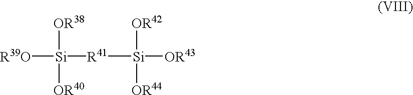

wherein R³⁸, R³⁹, R⁴⁰, R⁴², R⁴³ and R⁴⁴ are independently hydrocarbon groups; R⁴¹ is an alkylene or alkylidene group; and n is 0 or 1. The hydrocarbon groups preferably contain 1 to about 10 carbon atoms, more preferably 1 to about 6 carbon atoms, more preferably 1 to about 4 carbon atoms. These hydrocarbon groups are preferably alkyl (e.g., methyl, ethyl, propyl, and the like). The alkylene and alkylidene group preferably contains from 1 to about 10 carbon atoms, more preferably 1 to about 6 carbon atoms, more preferably 1 to about 4 carbon atoms. R⁴¹ group is preferably alkylene (e.g., methylene, ethylene, propylene, and the like).

The conductive polymeric composite comprises electrically conductive filler dispersed in a resin system and may optionally comprise thermally conductive particles. The conductive polymeric composite is homogeneous. A homogeneous polymeric composite in the sense of this specification excludes heterogeneous composite materials such as materials with an embedded screen or with embedded fibers which are comparable in length or longer than tₘᵢₙ, although the inventors anticipate that additional layers of such heterogeneous material may be attached subsequently to the homogeneous material.

When a polymeric coating is formed on a substrate, the polymeric coating may shrink during the cure process, resulting in strong residual stress between the substrate and the polymeric composite. In contrast, the linear shrinkage per unit length of the molded conductive polymeric composite in the X-Y plane is less than or equal to about 0.005, preferably less than or equal to about 0.003, and most preferably less than or equal to about 0.001. Linear shrinkage per unit length of the molded composite is defined by ASTM D-955. Generally speaking it is the amount of shrinkage either in length (Y-direction) or width (X-direction) versus the corresponding original part dimension.

Resins useful in the conductive polymeric composite include, but are not limited to, thermosetting resins, thermoplastic resins and combinations of resin compatible with the conductive filler described herein and capable of withstanding the electrochemical cell environment without degradation or leaching. Compatibility is defined herein as dispersing sufficient conductive filler to achieve the desired volume resistivity for the resulting electrochemical cell component. Preferred resins include epoxidized phenol novolac resins, epoxidized cresol novolac resins, polybutadiene, polyisoprene, polymers comprising repeating units of the formula:

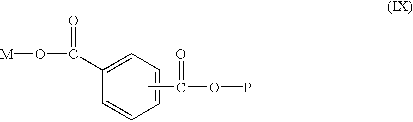

wherein P and M may be the same or different alkenes having from 2 to about 6 carbons, such as poly(diallyl phthalate), and combinations comprising at least one of the foregoing resins. A preferred thermosetting polybutadiene- or polyisoprene-based resin system comprises: (1) a polybutadiene or polyisoprene resin; (2) an optional functionalized liquid polybutadiene or polyisoprene resin; (3) an optional butadiene- or isoprene-containing polymer; and (4) an optional low molecular weight polymer. The polybutadiene or polyisoprene resins may be liquid or solid at room temperature. Liquid resins may have a molecular weight greater than 5,000, but preferably have a molecular weight of less than 5,000 (most preferably between 1,000 and 3,000). The preferably liquid (at room temperature) resin portion maintains the viscosity of the composition at a manageable level during processing to facilitate handling, and it also crosslinks during cure. Polybutadiene and polyisoprene resins having at least 90% 1,2-addition by weight are preferred because they exhibit the greatest crosslink density upon cure due to the large number of pendent vinyl groups available for crosslinking. High crosslink densities are desirable because the products exhibit superior performance in the electrochemical cell environment at elevated temperatures. A preferred resin is a low molecular weight polybutadiene liquid resin having greater than 90 weight percent (wt. %) 1,2-addition, commercially available from Nippon Soda Co., Ltd under the designation B3000.

The thermosetting polybutadiene- or polyisoprene-based resin system optionally comprises functionalized liquid polybutadiene or polyisoprene resins. Examples of appropriate functionalities for butadiene liquid resins include but are not limited to epoxy, maleate, hydroxy, carboxyl and methacrylate. Examples of useful liquid butadiene copolymers are butadiene-co-styrene and butadiene-co-acrylonitrile. Possible functionalized liquid polybutadiene resins include Nisso G-1000, G-2000, G-3000; Nisso C-1000; Nisso BN-1010, BN-2010, BN-3010, CN-1010; Nisso TE-2000; and Nisso BF-1000 commercially available from Nippon Soda Co., Ltd. and Ricon 131/MA commercially available from Colorado Chemical Specialties, Inc.

The optional butadiene- or isoprene-containing polymer is preferably unsaturated and can be liquid or solid. It is preferably a solid, thermoplastic elastomer comprising a linear or graft-type block copolymer having a polybutadiene or polyisoprene block, and a thermoplastic block that preferably is styrene or alpha-methyl styrene. Possible block copolymers, e.g., styrene-butadiene-styrene tri-block copolymers, include Vector 8508M (commercially available from Dexco Polymers, Houston, Tex.), Sol-T-6302 (commercially available from Enichem Elastomers American, Houston, Tex.), and Finaprene 401 (commercially available from Fina Oil and Chemical Company, Dallas, Tex.). Preferably, the copolymer is a styrene-butadiene di-block copolymer, such as Kraton D1118X (commercially available from Shell Chemical Corporation). Kraton D118X is a di-block styrene-butadiene copolymer containing 30 volume % styrene.

The butadiene- or isoprene-containing polymer may also contain a second block copolymer similar to the first except that the polybutadiene or polyisoprene block is hydrogenated, thereby forming a polyethylene block (in the case of polybutadiene) or an ethylene-propylene copolymer (in the case of polyisoprene). When used in conjunction with the first copolymer, materials with enhanced toughness can be produced. Where it is desired to use this second block copolymer, a preferred material is Kraton GX1855 (commercially available from Shell Chemical Corp.), which is believed to be a mixture of a styrene-high 1,2 butadiene-styrene block copolymer and a styrene-(ethylene-propylene)-styrene block copolymer.

Thus, in a preferred embodiment, the butadiene- or isoprene-containing polymer comprises a solid thermoplastic elastomer block copolymer having the formula Xₘ(Y-X)ₙ (linear copolymer) or

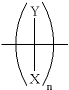

(graft polymer), where Y is a polybutadiene or polyisoprene block, X is a thermoplastic block, and m and n represent the average block numbers in the copolymer, m is 0 or 1 and n is at least 1. The composition may further include a second thermoplastic elastomer block copolymer having the formula Wₚ-(Z-W)_{q} (linear copolymer) or

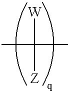

(graft copolymer) where Z is a polyethylene or ethylene-propylene copolymer block, W is a thermoplastic block, and p and q represent the average block numbers in the copolymer, p being 0 and 1 and q being at least 1.

The volume to volume ratio of the polybutadiene or polyisoprene resin to the optional butadiene- or isoprene-containing polymer preferably is between 1:9 and 9:1, inclusive. The selection of the butadiene- or isoprene-containing polymer depends on chemical and hydrolysis resistance as well as the toughness conferred upon the molded material.

The optional low molecular weight polymer resin is generally employed to enhance toughness and other desired characteristics of the conductive polymeric composite. Examples of suitable low molecular weight polymer resins include, but are not limited to, telechelic polymers such as polystyrene, multifunctional acrylate monomers and ethylene propylene diene monomer (EPDM) containing varying amounts of pendant norbornene groups and/or unsaturated functional groups. The optional low molecular weight polymer resin can be present in amounts of about 0 to about 30 wt % of the total resin composition.

Monomers with vinyl unsaturation, sometimes known as cross linking agents, may also be included in the resin system for specific property or processing conditions, such as to decrease the viscosity of the conductive moldable polymeric composite, especially with high filler loading. Viscosity is a key factor in obtaining acceptable molding rheologies. Inclusion of one or more monomers with vinyl unsaturation has the added benefit of increasing cross link density upon cure. Suitable monomers must be capable of co-reacting with one of the other resin system components. Examples of suitable monomers include styrene, vinyl toluene, divinyl benzene, triallylcyanurate, diallylphthalate, and multifunctional acrylate monomers (such as Sartomer compounds available from Arco Specialty Chemicals Co.), among others, all of which are commercially available. The useful amount of monomers with vinyl unsaturation is about 0% by weight to about 80% by weight of the resin composition and preferably about 3% to about 50%.

A curing agent is preferably added to the resin system to accelerate the curing reaction. When the composition is heated, the curing agent decomposes to form free radicals, which then initiate cross linking of the polymeric chains. Preferred curing agents are organic peroxides such as Luperox, dicumyl peroxide, t-butyl perbenzoate, 2,5-dimethyl-2,5-di(t-butyl peroxy)hexane, alpha, alpha-bis(t-butyl peroxy)diisopropylbenzene, and t-butylperoxyhexyne-3, all of which are commercially available. They may be used alone or in combination. Typical amounts of curing agent are from about 1.5 part per hundred parts of the total resin composition (PHR) to about 6 PHR.

Useful conductive fillers include metal fillers that do not leach, for example hollow and solid metal coated glass spheres, pure nickel (Ni), or 316 stainless steel. Carbonaceous conductive fillers are preferred due to their resistance to acid environments. Examples of carbonaceous fillers are carbon fibers, coke, natural and synthetic graphite powder, vapor grown carbon fibers, carbon nanotubes, carbon microtubes, carbon black, metallized graphite and chemically modified, e.g., coated carbon black with enhanced electrical properties. These fillers may be used alone or in combination. Combinations of filler may be desirable to maximize the packing density of the filler and thereby maximize the electrical conductivity of the molded composite.

Useful amounts of filler are about 10% to about 90% by volume of the total conductive polymeric composite. Alternately useful amounts of filler are about 19.5 weight percent (wt %) to about 95.0 weight percent (wt %), preferably about 50 to about 95 wt %, more preferably about 80 to about 95 wt % based on the total weight of the conductive molding polymeric composite. The fillers may have varying particle shapes, sizes and purities. Preferably some or all of the filler is in the form of fibers, microtubes, single wall or multi-wall graphite, single wall or multi-wall carbon nanotubes, platelets, or combinations comprising at least one of the foregoing filler forms. Fibers are herein defined as particles having a length to diameter ratio of at least about 2, preferably at least about 5 and more preferably at least about 100. Fibers having a length to diameter ratio of at least about 400 to about 10,000, which are known as high aspect ratio fillers, are preferred. Nanotubes and microtubes are exemplary high aspect ratio fillers. Platelets are herein defined as particles having two dimensions which are greater that a third dimension by at least a factor of two, preferably by greater than a factor of five. For example, the width and length are individually at least two times greater than the height, or the diameter of a disk-shaped particle is at least two times greater than the height. Platelets may have regular or irregular geometries. Use of filler comprising fiber and/or platelets helps to decrease the amount of shrinkage of the polymeric composite during cure. Particles wherein the longest single linear dimension is about 0.2 to 6000 micrometers may be used.

The conductive polybutadiene-or polyisoprene-based composite may further include various other additives for improving thermal conductivity, impact properties, mold-release properties, and thermo-oxidative stability. These additives are generally non-electrically conductive. Thermal conductivity can be improved with the addition of metal oxides, nitrides, carbonates or carbides (hereinafter sometimes referred to as “ceramic additives”). Such additives can be in the form of powders, flakes or fibers. Exemplary materials include oxides, carbides, carbonates, and nitrides of tin, zinc, copper, molybdenum, calcium, titanium, zirconium, boron, silicon, yttrium, aluminum or magnesium; mica; glass ceramic materials; or fused silica. When present, the thermally conducting materials are preferably present between about 60 to about 200 parts of thermally conducting material per 100 parts of total resin (“PHR”), and more preferably about 80 to about 180 PHR. The amounts of the above additives should not impair molding operations.

In general, the conductive polymeric composite is processed as follows. First, all the components (ingredients of the resin system, curing agent, filler and volatile solvent when necessary) are thoroughly mixed in conventional mixing equipment. The mixing temperature is regulated to avoid substantial decomposition of the curing agent (and thus premature cure). Additionally, a small amount of an inhibitor, about 50 to about 350 parts per million by weight of resin, may be added to protect against peroxide decomposition. Mixing continues until the filler is uniformly dispersed through the resin. Additional solvent may be added to facilitate the formation of small particles. The homogenized mixture is then removed, cooled, and dried. If necessary the material may be deagglomerated by passing it through a coarse screen.

The electrochemical cell component is usually made by first lightly abrading or etching the core. Abrading may be accomplished by any method known in the art such as buffing, scrubbing, or grit blasting. Etching may be accomplished by liquid dip, spray etching, electrochemical etching, plasma etching or other chemical etching technique. After abrading or etching the core may be rinsed with an appropriate solvent such as acetone. A dilute solution of the adhesion promoter in a suitable volatile solvent may then be applied to the cleaned area of the core by dip coating, spray coating or other suitable application methods such as with a brush. An effective concentration of the dilute solution is readily determined by one of ordinary skill in the art, but is typically in the range of about 0.1% to about 9%, preferably about 1% to about 5%. Suitable volatile solvents include acetone and methyl ethyl ketone (MEK), among others. The solvent is removed from the surface of the core by evaporation, for example in a hot-air circulating oven at a temperature of about 35° C. to about 60° C., more preferably about 35° C. to about 50° C. Final drying temperature is dictated by solvent(s) used for any given adhesion promoter or mixtures thereof. Without being bound by theory it is believed that heating at an elevated temperature, i.e., greater than about 35° C., may promote a chemical reaction between the surface of the core and the adhesion promoter that aids in increasing adhesion. The adhesion promoter coated core is subsequently used for electrochemical cell component manufacturing with the conductive polymeric composite using any suitable method known in the art, such as compression molding, transfer molding, injection molding or the like. As will be readily appreciated by one of ordinary skill in the art the method of applying the conductive polymeric composites is dependent upon the composition and physical properties such as the flow properties of the conductive composite formulation.

The conductive polymeric composite may then be cured, if necessary, by any suitable method known in the art such as a one-step cure or a two-step cure. The first step of a two-step cure process is a conventional peroxide cure step; and typical cure temperatures are between about 150° C. and about 200° C. If the method used to apply the conductive polymeric composite materials heats the conductive polymeric composite to a temperature between about 150° C. and about 200° C., then the application step also constitutes the first cure step. Compression molding is one method of applying the conductive polymeric coating that also functions as the first cure step. The second step of the cure process can either be a high temperature cure or high-energy electron beam cure (E-beam cure) or other irradiation cure. A high temperature cure comprises heating the article to temperatures greater than about 230° C. but less than the decomposition temperature of the material, generally about 400° C. under an inert atmosphere. E-beam curing is advantageous because it allows for controlled curing for a given system. The amount of curing (cross linking) is controlled by the total amount of radiation given to the article. The ability of the high-energy electrons to penetrate through the sample to specific depth is known as the penetration depth. The E-beam source voltage controls the penetration depth, and different sources give different penetration depths.

Especially preferred electrochemical cell components, made as described above, include bipolar plates, end plates, current collectors and combinations of the foregoing.

The method of the invention is further illustrated by the following example, which is meant to be illustrative, not limiting.

All of the above identified references, patents, and patent applications are hereby incorporated herein by reference in their entirety including incorporated material.

### EXAMPLES

### Example 1

Aluminum plates 0.07 cm thick, 10.7 cm wide and 11.0 cm long were lightly abraded with sand-paper or other abrading means and subsequently washed with acetone and then pretreated with a 5% by weight solution of mercapto-functional silane, available from OSi Specialties under the trade name A-189, in acetone by dip coating. The solvent was allowed to evaporate under ambient conditions. The plate was subsequently transferred to a preheated die. A suitable amount of a conductive polybutadiene composite material was weighed out for proper fill of the mold cavity. The composition of the conductive polybutadiene composite material is shown in Table 1. The conductive polybutadiene composite was put into the mold cavity and compression molded onto the surface of the plate at 150° C. mold temperature, 10,000-12,000 pounds per square inch (psi) cavity pressure for 4 minutes. A typical dimension of the molded conductive polymeric composite is 10.6 cm×4.4 cm×0.5 cm. The final dimension for a finished part is dictated by the design and end-use requirements. These samples were further cured in an oven at 240° C. for 4 hours or longer depending on the degree of cure desired.

TABLE 1

| Component | Source, Trade Name | Vol. % |
|---|---|---|
| Liquid polybutadiene resin | Nisso B-3000 | 24.6 |
| Trimethylolpropane | Sartomer SR-350 | 2.3 |
| trimethacrylate | | |
| t-Butyl perbenzoate | Triganox-C | 0.22 |
| Peroxide | Luprox 5OOR or Perkadox BC | 2.22 |
| Di-t-butyl-p-cresol | Ionol | 0.04 |
| Natural graphite | Asbury Graphite Mill, Inc., | 46.6 |
| | Asbury 3621 | |
| Synthetic graphite | Asbury Graphite Mill, Inc., | 24.0 |
| | Asbury A99 | |

The molded conductive polymeric composite/aluminum part was visually inspected for mechanical integrity and interfacial adhesion between the matrix and metal. These parts have very good electrical and solvent resistance properties. The cured composite material is rigid with good dimensional stability. As the composite/aluminum parts were heated and cooled in cooling cycles, no bowing of the samples were noted, proving that the temperature coefficient of expansion of the composite matched that of the aluminum. The composite/aluminum part had a volume resistivity of 0.052 ohm-cm according to IPC TM-650 and a thermal conductivity of 10.5 watts/meter ° K according to ASTM C518.

### Example 2

Aluminum plates 0.07 cm thick, 10.7 cm wide and 11.0 cm long were lightly abraded with sand-paper or other abrading means and subsequently washed with acetone and then pretreated with a 5% by weight solution of an amino silane, available from OSi Specialties under the trade name A1106, in acetone by dip coating. The solvent was allowed to evaporate under ambient conditions. The plate was subsequently transferred to a preheated die. A suitable amount of a conductive epoxy-based composite material was weighed out for proper fill of the mold cavity. The composition of the conductive epoxy-based composite material is shown in Table 2. The conductive polymeric composite was put into the mold cavity and compression molded onto the surface of the plate at 180° C. mold temperature, 10,000-12,000 pounds per square inch (psi) cavity pressure for 4 minutes. A typical dimension of the molded conductive polymeric composite is 10.6 cm×4.4 cm×0.5 cm. The final dimension for a finished part is dictated by the design and end-use requirements. These samples were further cured in an oven at 240° C. for 4 hours or longer depending on the degree of cure desired.

TABLE 2

| Component | Source, Trade Name | Vol. % |
|---|---|---|
| Epoxidized cresol novolac | Sumitomo Chemical Co., | 11.73 |
| resin | Sumiepoxy ESCN 195XL 25 | |
| Epoxidized phenol novolac | DaiNippon Ink and Chemicals, | 10.14 |
| resin | Epiclon N-770 | |
| Natural graphite | Asbury Graphite Mill, Inc., | 40.02 |
| | Asbury 3621 | |
| Synthetic graphite | Asbury Graphite Mill, Inc., | 20.69 |
| | Asbury A99 | |
| Calcium stearate | Mallinckrodt, Inc. | 3.45 |
| Phenol-formaldehyde | Schenectady International, | 13.59 |
| polymer | HRJ 11040 | |
| 2,4,6-tris dimethyl-amino | Air Products and Chemicals, | 0.21 |
| methyl phenol | Ancamine K54 | |
| Glycerol mono stearate | Lonza Group, Lonzest GMS | 0.17 |

The molded conductive polymeric composite/aluminum part was visually inspected for mechanical integrity and interfacial adhesion between the matrix and metal. These parts have very good electrical and solvent resistance properties. The cured composite material is rigid with good dimensional stability. As the composite/aluminum parts were heated and cooled in cooling cycles, no bowing of the samples were noted, proving that the temperature coefficient of expansion of the composite matched that of the aluminum. The composite/aluminum part had a volume resistivity of 0.068 ohm-cm according to IPC TM-650 and a thermal conductivity of 13.4 watts/meter ° K according to ASTM C518.

### Example 3

Aluminum plates 0.07 cm thick, 10.7 cm wide and 11.0 cm long were lightly abraded with sand-paper or other abrading means and subsequently washed with acetone and then pretreated with a 5% by weight solution of a vinyl silane, available from OSi Specialties under the trade name A172, in acetone by dip coating. The solvent was allowed to evaporate under ambient conditions. The plate was subsequently transferred to a preheated die. A suitable amount of a conductive epoxy-based composite material was weighed out for proper fill of the mold cavity. The composition of the conductive poly(diallyl phthalate) composite material is shown in Table 3. The conductive polymeric composite was put into the mold cavity and compression molded onto the surface of the plate at 180° C. mold temperature, 10,000-12,000 pounds per square inch (psi) cavity pressure for 4 minutes. A typical dimension of the molded conductive polymeric composite is 10.6 cm×4.4 cm×0.5 cm. The final dimension for a finished part is dictated by the design and end-use requirements.

TABLE 3

| Component | Source, Trade Name | Vol % |
|---|---|---|
| Poly(diallyl phthalate) | Daiso Company, Ltd., Daiso A | 13.44 |
| Poly(diallyl phthalate) | Daiso Company, Ltd., Daiso K | 6.72 |
| Natural graphite | Asbury Graphite Mill, Inc., | 50.96 |
| | Asbury 3621 | |
| Synthetic graphite | Asbury Graphite Mill, Inc., | 26.29 |
| | Asbury A99 | |
| Diallyl phthalate monomer | Daiso Company, Ltd. | 0.38 |
| Trimethyloipropane | Sigma Aldrich, Sartomer 350 | .087 |
| trimethylacrylate | | |
| t-Butyl perbenzoate | Akzo Nobel, Triganox C | 0.84 |
| Dicumyl peroxide | Akzo Nobel, Perkadox BC | 0.47 |
| Butyrated hydroxy toluene | PMC Specialty Group, Ionol | .04 |

The molded conductive polymeric composite/aluminum part was visually inspected for mechanical integrity and interfacial adhesion between the matrix and metal. These parts have very good electrical and solvent resistance properties. The composite material is rigid with good dimensional stability. As the composite/aluminum parts were heated and cooled in cooling cycles, no bowing of the samples were noted, proving that the temperature coefficient of expansion of the composite matched that of the aluminum. The composite/aluminum part had a volume resistivity of 0.0567 ohm-cm according to IPC TM-650 and a thermal conductivity of 7.82 watts/meter ° K according to ASTM C-518.

As seen in the preceding examples the electrochemical cell component has excellent chemical resistance, good mechanical integrity, and good conductivity. Notably, the conductive polymeric composite of the electrochemical cell component does not separate from the core under electrochemical cell conditions. Furthermore they have a volume resistivity of about 0.500 ohm-cm or less, preferably about 0.116 ohm-cm or less, more preferably about 0.045 ohm-cm or less, and a thermal conductivity of at least about 5 watts/meter ° K, preferably about 7 watts/meter ° K, and more preferably at least about 13 watts/meter ° K. In addition, it is economical to produce because it can be produced using currently available methods and equipment.

While preferred embodiments have been shown and described, various modifications and substitutions may be made thereto without departing from the spirit and scope of the invention. Accordingly, it is to be understood that the present invention has been described by way of illustration and not limitations.

We claim:

1. An apparatus comprising:
an electrochemical cell electrically conductive support comprising
a conductive core comprising an active area; and
an electrically and thermally conductive polymeric composite substantially covering the active area of the conductive core.

2. An apparatus according to claim 1, wherein the thermally conductive core comprises a metal or metal alloy.

3. An apparatus according to claim 2, wherein the metal or metal alloy is selected from the group consisting of aluminum, copper, magnesium, and combinations thereof.

4. An apparatus according to claim 1, wherein the electrochemical cell electrically conductive support additionally comprises at least one channel for conducting a fluid.

5. An apparatus according to claim 4, wherein the at least one channel is an exterior channel for conducting fuel gas, fuel liquid, oxidant gas or oxidant liquid.

6. An apparatus according to claim 4, wherein the at least one channel is an interior channel for conducting cooling fluid.

7. An apparatus according to claim 1, wherein the conductive core additionally comprises a heat transfer area extending beyond the active area.

8. An apparatus according to claim 7, wherein the heat transfer area is in the form of a cooling fin.

9. An apparatus according to claim 1, wherein a thermal coefficient of expansion of the conductive core is substantially the same as a thermal coefficient of expansion of the electrically and thermally conductive polymer composite, over an operative temperature range of the fuel cell.

10. An apparatus according to claim 1, where volume resistivity of the electrically conductive polymer support is less than about 0.5000 ohm-cm.

11. A system comprising:
a plurality of electrochemical cell electrically conductive supports comprising
a conductive core comprising an active area; and
an electrically and thermally conductive polymer composite substantially
covering the active area of the conductive core;
gas supply means for supplying fuel gases and oxidant gases to the fuel cell membranes;
electrical means for transporting electrical charge to and from the fuel cell membranes;
electrical means for conditioning power produced by the plurality of fuel cell membranes; and
control means for controlling the fuel gases, oxidant gases and electrical means.

12. A system according to claim 11, wherein at least one substrate has interior channels for channeling a cooling fluid.

13. A system according to claim 12, further comprising means for supplying cooling fluid to the interior channels.

14. A system according to claim 11, wherein the conductive core additionally comprises a heat transfer area extending beyond the active area.

15. A system according to claim 11, further comprising means for supplying cooling fluid to the heat transfer area.

16. A system according to claim 15, wherein the cooling fluid is air.

17. An apparatus, comprising
an electrochemical cell electrically conductive support comprising
a conductive core comprising an active area; and
an electrically and thermally conductive polymeric composite substantially covering the active area and adhered thereto by an adhesion promoter.

18. The apparatus of claim 17, wherein the adhesion promoter is a silane, titanate, or zirconate adhesion promoter.

19. The apparatus of claim 17, wherein all or part of the conductive filler is in the form of fibers, platelets, or a combination of fibers and platelets.

20. The apparatus of claim 17, wherein the conductive support has a volume resistivity of about 0.116 ohm-cm or less.

21. The apparatus of claim 17, wherein the conductive support has a thermal conductivity of at least about 5 watts/meter ° K.

22. The apparatus of claim 17, wherein the conductive polymer composite when molded has a linear shrinkage per unit length of the molded composite in the X-Y plane of less than or equal to about 0.005.

23. The apparatus of claim 17, wherein the conductive core comprises metals selected from the group consisting of aluminum, aluminum alloys, nickel, nickel alloys, copper, platinum, magnesium, magnesium alloys, titanium, gold plated metals, and stainless steel.

24. The apparatus of claim 23, wherein the conductive polymer composite is a polybutadiene- or polyisoprene-based composite.

25. The apparatus of claim 24, wherein the adhesion promoter is chemically bonded with both the conductive core and the conductive polybutadiene- or polyisoprene-based composite.

26. The apparatus of claim 24, wherein the adhesion promoter is a mercapto-functional silane or vinyl silane.

27. The apparatus of claim 24, wherein the conductive polybutadiene- or polyisoprene-based composite comprises a conductive filler, a thermosetting polybutadiene or polyisoprene resin and an unsaturated butadiene- or isoprene-containing polymer capable of participating in cross-linking with the polybutadiene or polyisoprene resin during cure, and further wherein the volume to volume ratio of the polybutadiene or polyisoprene resin to the unsaturated butadiene- or isoprene-containing polymer is between 1:9 and 9:1, inclusive.

28. The apparatus of claim 27, wherein the conductive polybutadiene- or polyisoprene-based composite further comprises a functionalized liquid polybutadiene or polyisoprene resin.

29. The apparatus claim 27, wherein the conductive polybutadiene- or polyisoprene-based composite comprises, based on the total coating, about 10 volume % to about 90 volume % of the filler.

30. The apparatus of claim 27, wherein the filler is synthetic graphite.

31. The apparatus of claim 27, wherein the conductive polybutadiene-or polyisoprene-based composite further comprises at least one monomer with vinyl unsaturation.

32. The apparatus of claim 31, wherein the at least one monomer with vinyl unsaturation is selected from the group consisting of styrene, vinyl toluene, divinyl benzene, triallylcyanurate, diallylphthalate, and multifunctional acrylate monomers.

33. The apparatus of claim 27, wherein the unsaturated butadiene- or isoprene-containing polymer is a copolymer of isoprene or butadiene and a second monomer.

34. The apparatus of claim 33, wherein the unsaturated butadiene- or isoprene-containing copolymer is solid.

35. The apparatus of claim 33, wherein the unsaturated butadiene- or isoprene-containing polymer is a block copolymer.

36. The apparatus of claim 35, wherein the unsaturated butadiene-or isoprene-containing polymer is a styrene-butadiene or a methyl styrene-butadiene di-block polymer.

37. The apparatus of claim 35, wherein the unsaturated butadiene- or isoprene-containing polymer is a thermoplastic elastomer block copolymer having one of the formula 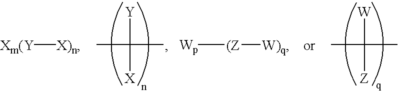
wherein each formula Y is a block comprising isoprene or butadiene units, X is a thermoplastic block, and m and n represent the average block numbers in said copolymer, m being 0 or 1 and n being at least 1; and Z is a polyethylene or ethylene-propylene copolymer block, W is thermoplastic block, and p and q represent the average block members in said copolymer, p being 0 or 1 and q being at least 1.

38. The apparatus of claim 24, wherein the polybutadiene or polyisoprene resin has a molecular weight of less than 5,000.

39. The apparatus of claim 23, wherein the conductive polymeric composite comprises epoxidized phenol novolac resin, epoxidized cresol novolac resin, polymers based on unsaturated vinyl esters, and combinations comprising at least one of the foregoing resins.

40. An electrochemical cell component comprising;
a conductive core; and
an electrically and thermally conductive polymer composite substantially covering and adhered to the core by an adhesion promoter, wherein the electrochemical cell component has a volume resistivity of about 0.116 ohm-cm or less.

41. The component of claim 40, wherein the adhesion promoter is a silane, titanate, or zirconate adhesion promoter.

42. The component of claim 40, wherein all or part of the conductive filler is in the form of fibers, platelets, or a combination of fibers and platelets.

43. The component of claim 40, wherein the conductive support has a thermal conductivity of at least about 5 watts/meter ° K.

44. The component of claim 40, wherein the conductive polymer composite when molded has a linear shrinkage per unit length of the molded composite in the X-Y plane of less than or equal to about 0.005.

45. The component of claim 40, wherein the conductive core comprises metals selected from the group consisting of aluminum, aluminum alloys, nickel, nickel alloys, copper, platinum, magnesium, magnesium alloys, titanium, gold plated metals, and stainless steel.

46. The component of claim 45, wherein the conductive polymer composite is a polybutadiene- or polyisoprene-based composite.

47. The component of claim 46, wherein the adhesion promoter is chemically bonded with both the conductive core and the conductive polybutadiene-or polyisoprene-based composite.

48. The component of claim 46, wherein the adhesion promoter is a mercapto-functional silane or vinyl silane.

49. The component of claim 46, wherein the conductive polybutadiene- or polyisoprene-based composite comprises a conductive filler, a thermosetting polybutadiene or polyisoprene resin and an unsaturated butadiene- or isoprene-containing polymer capable of participating in cross-linking with the polybutadiene or polyisoprene resin during cure, and further wherein the volume to volume ratio of the polybutadiene or polyisoprene resin to the unsaturated butadiene- or isoprene-containing polymer is between 1:9 and 9:1, inclusive.

50. The component of claim 49, wherein the conductive polybutadiene- or polyisoprene-based composite further comprises a functionalized liquid polybutadiene or polyisoprene resin.

51. The component of claim 49, wherein the conductive polybutadiene- or polyisoprene-based composite comprises, based on the composite, about 10 volume % to about 90 volume % of the conductive filler.

52. The component of claim 49, wherein the filler is synthetic graphite.

53. The component of claim 49, wherein the conductive polybutadiene-or polyisoprene-based composite further comprises at least one monomer with vinyl unsaturation.

54. The component of claim 53, wherein the at least one monomer with vinyl unsaturation is selected from the group consisting of styrene, vinyl toluene, divinyl benzene, triallylcyanurate, diallylphthalate, and multifunctional acrylate monomers.

55. The component of claim 49, wherein the unsaturated butadiene- or isoprene-containing polymer is a copolymer of isoprene or butadiene and a second monomer.

56. The component of claim 55, wherein the unsaturated butadiene- or isoprene-containing copolymer is solid.

57. The component of claim 55, wherein the unsaturated butadiene- or isoprene-containing polymer is a block copolymer.

58. The component of claim 57, wherein the unsaturated butadiene- or isoprene-containing polymer is a styrene-butadiene or a methyl butadiene-butadiene di-block polymer.

59. The component of claim 57, wherein the unsaturated butadiene- or isoprene-containing polymer is a thermoplastic elastomer block copolymer having one of the formula 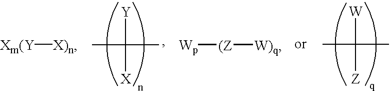
wherein each formula Y is a block comprising isoprene or butadiene units, X is a thermoplastic block, and m and n represent the average block numbers in said copolymer, m being 0 or 1 and n being at least 1; and Z is a polyethylene or ethylene-propylene copolymer block, W is thermoplastic block, and p and q represent the average block members in said copolymer, p being 0 or 1 and q being at least 1.

60. The apparatus of claim 45, wherein the conductive polymeric composite comprises epoxidized phenol novolac resin, epoxidized cresol novolac resin, poly(diallyl phthalate), and combinations comprising at least one of the foregoing resins.

61. An electrochemical cell component comprising;
a conductive core; and
an electrically and thermally conductive polybutadiene- or polyisoprene-based composite substantially covering and adhered to the core by an adhesion promoter, wherein linear shrinkage per unit length of the molded conductive polymer composite in the X-Y plane is less than or equal to about 0.005.

62. An electrochemical cell component comprising;
a conductive core; and
an electrically and thermally conductive polybutadiene- or polyisoprene-based composite substantially covering and adhered to the core by an adhesion promoter, wherein the polymer composite comprises conductive filler in the form of fibers, platelets, or a combination of fibers and platelets.
